(19) United States
(12) Patent Application Publication
(10) Pub. No.: US 2018/0364664 A1
(43) Pub. Date: Dec. 20, 2018

(54) PERSONALIZED ACTIONABLE ENERGY MANAGEMENT BASED ON LOAD DISAMBIGUATION

(71) Applicant: Avista Corporation, Spokane, WA (US)

(72) Inventors: Mark Wayne Gustafson, Spokane, WA (US); Amanda Susan Figy, Nine Mile Falls, WA (US); Curtis Allen Kirkeby, Spokane, WA (US)

(73) Assignee: Avista Corporation

(21) Appl. No.: 16/009,667

(22) Filed: Jun. 15, 2018

Related U.S. Application Data
(60) Provisional application No. 62/520,448, filed on Jun. 15, 2017.

(51) Int. Cl. G05B 19/042

(52) U.S. Cl. CPC G05B 19/042; G05B 2219/2639

(57) ABSTRACT

Systems and methods for personalizing actionable energy management based on disambiguated energy use data includes receiving disambiguated energy use data associated with a user, receiving a user request from the user for energy use information associated with the disambiguated energy use data, based on the disambiguated energy use data and the user request, determining a personalized energy management action; and providing the personalized energy management action to the user. A task consistent with the personalized energy management action may be performed automatically, and a confirmation of the task completion is provided to the user.

This application is a non-provisional of, and claims priority to and the benefit of, U.S. Provisional Patent Application Ser. No. 62/520,448, filed Jun. 15, 2017 and entitled “LOAD DISAGGREGATION VIA NON-INTRUSIVE LOAD MONITORING (NILM),” the entirety of which is incorporated herein by reference.

### BACKGROUND

A new generation of customers, who may be sometimes referred as a millennial, are looking for, and are interested in, new ways to interact with the Utilities, such as residential gas, electric, and water providers, outside of traditional channels, and understanding actionable and accurate ways to conserve resources that are provided. Additionally, the Utilities are concerned about their potential loss of relevance as disrupting technologies in the consumer space continue to grow, specifically in a home area network, or a home ecosystem, which includes four primary areas: Security, Home Entertainment/Media, Health and Fitness, and Energy Management. By 2020, it is predicted that 85% of customers are likely to opt for connected home solutions that are linked to the home ecosystem connecting the four areas. There is an opportunity for the Utilities to enter into this rapidly evolving home ecosystem, and product managers offering connected home solutions may need to consider how to attach themselves to these ecosystems.

Energy choice is no longer an industry term for customers' ability to choose their retail energy supplier(s). Rather, choice refers to how our customers are empowered to participate in energy in ways that matter most to them and personalized for them. Whether it is to build their brand and image, join a social movement, have backup power, or reduce their energy consumption or costs, the new generation of customers demand more energy choices. Furthermore, to make those informed choices, the customers may require a frictionless view into their energy consumption and production 24 hours a day/7 days a week. Non-intrusive load monitoring (NILM) is an analytic and/or physics including harmonics based approach used to disaggregate, or disambiguate, building loads, such as electrical, gas, and water loads, based on a single metering point generating physics based measures. However, load disaggregation techniques have not allowed the customers to make decisions or action regarding their utility.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment in which personalized actionable energy management may be practiced.

FIG. 2 illustrates an example connected home ecosystem for the house of the user.

FIG. 3 illustrates an example flowchart describing a process of the personalized actionable energy management.

FIG. 4 illustrates an example conversation flow of a customer with a virtual assistant (VA) working in conjunction with the NILM system.

FIG. 5 illustrates an example computing device that may implement the system and methods for personalizing actionable energy management.

### DETAILED DESCRIPTION

Systems and methods discussed herein are directed to providing a personalized actionable energy management for a user, and more specifically to providing a personalized energy management action to the user based on load disambiguation and a user request, and performing tasks consistent with the personalized energy management action.

Techniques and mechanisms to provide the personalized actionable energy management may include creating a modern vertical natural language library around residential energy consumption in the form of a virtual assistant fully integrated into a horizontal natural language home ecosystem utilizing home automation devices. The user, who may be interchangeably referred as a customer, may communicate with the virtual assistant through the home automation devices with actionable information about his/her energy consumption using natural language. For electric energy, the virtual assistant may have access to actionable information in part using near real time non-intrusive load management (NILM) technology to disaggregate, or disambiguate, at the smart meter and or at the distribution board (residential breaker panel) in homes where smart meters are not yet installed. In addition, the virtual assistant may serve actionable information from Utility central billing and customer information systems. The customer may still engage with the Utility customer service through other traditional channels, for example, escalation of issues not suitably handled by the virtual assistant.

The NILM is a technique, which may include analytical, physics, data science, and the like, used to disaggregate, or disambiguate, a monitored load based on available data and/or information at a single metering point. The monitored load may include measurable quantities such as voltage, current, volume, temperature, time, and the like. This load monitoring and disambiguation technique may provide and enable alternative approaches for energy conservation, energy efficiency, and demand response to high-priced traditional sub-metering. Data for, and results of, the NILM may be communicated via a smart meter to a data center where the analysis of the data may be performed and results of the analysis may be generated. The data center may be centrally located, such as a building housing computing devices or cloud services which have distributed computing devices. Alternatively, smart devices, such as non-meter Internet of things (IoT) devices, may provide the data in addition to, or in place of, the smart meter.

Artificial intelligence (AI) user experience, for customer interactions with the Utility provider based on the NILM and specific uses cases around NILM capabilities, may be provided through an omni channel AI/natural language user experiences. For example, customers might not have the means to understand their usage through traditional NILM solutions, and as such, they may need a virtual energy advisor to interpret NILM results into meaningful or automatic action (with notification). The virtual energy advisor may interact with the customer regarding how the customer uses energy in near real time and in real time, or demand response, through the NILM results via a customer device or a home automation device, thorough a communication network, such as the Internet, wireless networks, an advanced metering infrastructure (AMI), and the like.

The utility provider may provide the customer with actionable and timely information and decisions about the customer's energy consumption as well as increasing the efficacy of distribution resource management through channels that are convenient for them, such as web and mobile applications and voice-based systems including, phone calls, emails, SMS messages, social media, and the like. Residential energy decisions may be integrated with demand side management (DSM) programs, demand-response (DR) programs and other benefits such as upgrading home equipment, modifying behavior to optimize savings, and more accurate budget for energy costs.

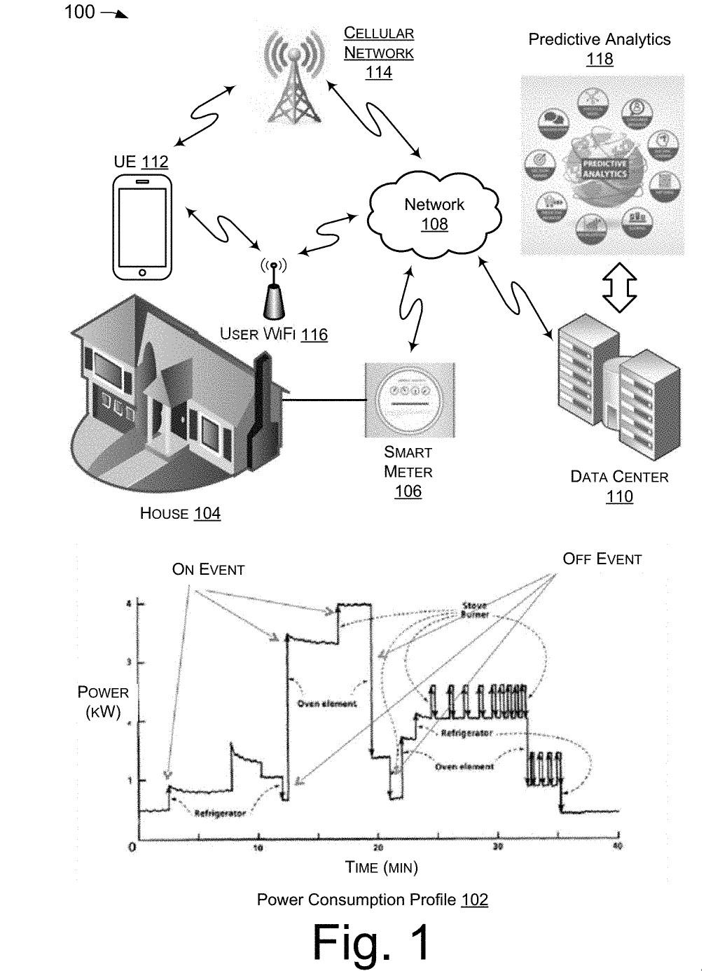

FIG. 1 illustrates an example environment 100 in which a personalized actionable energy management utilizing a NILM system may be practiced. A power consumption profile 102 is an example graph of power consumed over a time interval (40 minutes shown), and illustrates an aggregated power consumption by appliances (refrigerator and oven elements shown as examples) in a house 104 of a user. The power consumption profile 102 may be obtained by a power meter, such as a smart meter 106, and sent through a network 108, such as a wireless communication network, an advanced metering infrastructure (AMI), the Internet, and the like, to a data center 110 where analysis, such as disambiguation, of the power consumption profile 102 may be performed. The disambiguated information, or disambiguated energy use data, such as On Event and Off Event marked on the power consumption profile 102, may be transmitted back through the network 108 to the user. The disambiguated information may also be transmitted to, and stored on, the smart meter 106 such that previous events and data associated with the previous events that have already been disambiguated need not be re-sent to the data center 110 for future analysis. The user may receive the disambiguated energy use data on his user equipment (UE) 112, such as a mobile device, a personal computer, a tablet, and the like, via a cellular network 114 or a user Wi-Fi 116. Predictive analytics 118 may also be performed on collected data, such as the power consumption profile 102. Additionally, or alternatively, edge NILM analytics may be performed based on the data collected from the smart meter 106, non-meter Internet of things (IoT) devices, and/or meter collars (not shown). The NILM analysis may be based on proprietary and/or third party-supplied databases and processes. The edge NILM analytics, including edge predictive analytics may be performed using second or sub-second smart meter data, where the analytics take place at the meter or other IoT device, and only actionable results may be transmitted back to the house 104. The NILM analytics may also allow for future potential use cases, where combined analytics with other critical infrastructure services (such as water and gas) or any third party data or information may enable actionable insight and provide additional value to utility customers. The third party data or information may include weather, demographics of the user's neighborhood/subdivision, classification by income, square footage, and the like.

In addition to the disambiguated energy use data, the user, i.e., the UE 112, may receive from the data center 110 additional information such as notifications, actions to be taken, notices of actions taken, and responses. The data center 110 may send the disambiguated energy use data and the other information to the UE 112 periodically via the network 108, such as a default time interval or a user selected interval, based on a specific event that is preselected or the user-selected, or in response to a user inquiry. Additionally, or alternatively, the smart meter 106 may communicate to the UE 112 the additional information directly, or via power line communication (PLC) or a user home network, such as the user Wi-Fi 116.

The user may interact with the utility provider via the UE 112 using a virtual assistant to access various services. The virtual assistant may integrate commercial available voice-based system into the personalized actionable energy management. The virtual assistant may provide user customer information, and take an action with respect to service or with respect to the service provider. For example, the user may request the virtual assistant, using natural language, to change a setting of a thermostat in the house based on NILM data received. The virtual assistant may pass the request through a natural language library to determine the content of the request. Based at least in part on this determination, the virtual assistant may pass the request to data center 110 to analyze the request and determine a response to the request. The determining the response may be based at least in part on predictive analytics, NILM analysis, proprietary databases, third party databases, or combinations thereof among others. Additionally, or alternatively, the user may request the virtual assistant to perform a customer service related action, such as looking up account information, paying a bill, requesting a service, and the like.

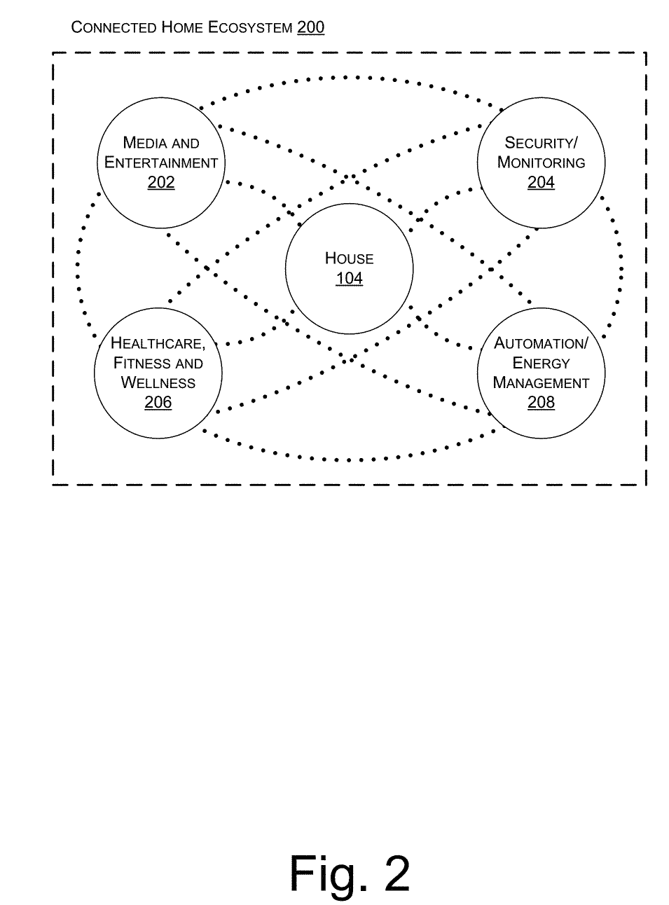

FIG. 2 illustrates an example connected home ecosystem 200 for the house 104 of the user.

In the connected home ecosystem 200, the house 104 may be connected to various integrated or ad hoc systems, such as media and entertainment systems and services 202, security/monitoring systems and services 204, healthcare, fitness, and wellness systems and services 206, and automation or energy management systems and services 208.

As a part of the connected home ecosystem 200 of connected devices and services, some customer experience features may benefit from the use of NILM based systems and services. For example, keeping an interface, such as a communication interface, between the user and infrastructure available may assist the user in properly using products, installing the products along with hardware needs that affect product cost, for example, keeping the system simple enough to install, but maintain effective functionality, and making decisions regarding actions to be taken at time frames required for certain applications based on energy outputs received by the user.

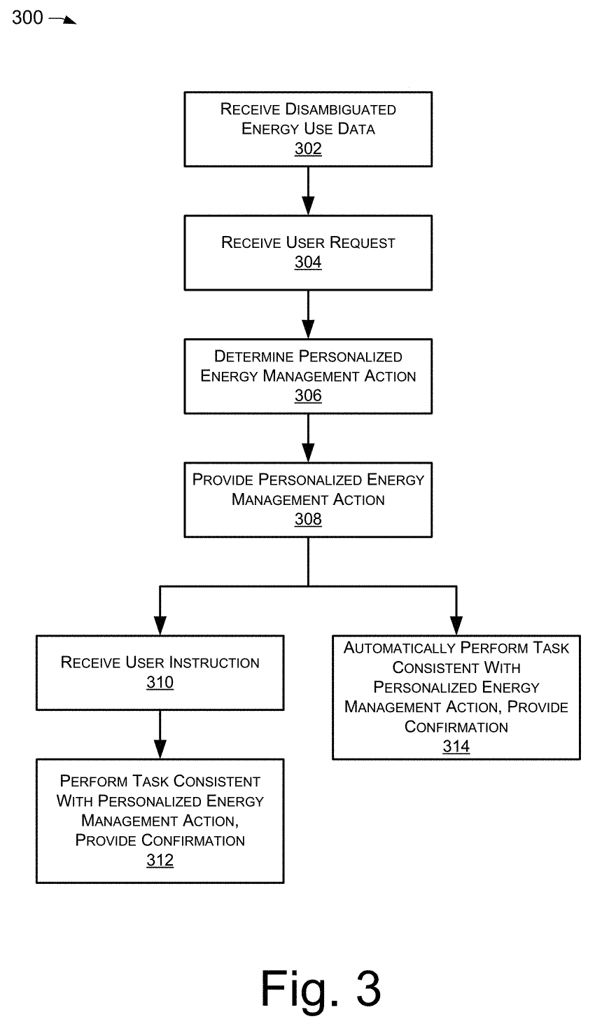

FIG. 3 illustrates an example flowchart 300 describing a process of the personalized actionable energy management.

At block 302, the NILM system may receive disambiguated energy use data associated with a user, i.e., a house, business, or an account associated with the user, such as the house 104 or a utility account of the user for the house 104. The NILM system may receive the disambiguated energy use data periodically at a predetermined time interval, upon receiving a user inquiry or request associated with the disambiguated energy use data, or upon an occurrence of a preselected event. The disambiguated energy use data may include information regarding when a refrigerator turned on and associated energy consumption, and when the oven turned on/off and associated energy consumption as illustrated in the power consumption profile 102 of FIG. 1. The NILM system may receive aggregated energy use data associated with the user, i.e., the house 104, via the smart meter 106 as described above with reference to FIG. 1, and disambiguate, or disaggregate, the aggregated energy use data to generate the disambiguated energy use data. The NILM system may alternatively transmit the aggregated energy use data to an external service to be disambiguated, and receive the disambiguated energy use data from the external service. Both the NILM system and the external service may apply a NILM technique to the aggregated energy use data to generate the disambiguated energy use data. The NILM technique may comprise at least one of artificial intelligence techniques, machine learning techniques, state machine modeling techniques, or operational research (OR) techniques. The OR techniques may be utilized to optimize the best actions or demand-response actions, then rank the actions. The OR techniques may also combine the optimization with needs of a smart grid as well as assistance in smart grid optimization decisions. Additionally, or alternatively, the NILM system may receive the disambiguated energy use data individually from a plurality of devices, such as IoT devices capable of communicating to the NILM system directly.

At block 304, the NILM system may receive a user request from the user for energy use information associated with the disambiguated energy use data, and based on the disambiguated energy use data and the user request, the NILM system may automatically determining a personalized energy management action at block 306. The NILM system may automatically determine the personalized energy management action based further on at least one of artificial intelligence, machine learning, natural language, or operation research understanding applied to the user request. For example, the NILM system may recognize certain patterns from previous user requests, recognize the user's speech. The user may also store user preferences regarding personalizing the energy consumption management. For example, the user may preselect a certain action for certain disambiguated energy use data, and store the preselected action in the NILM system as a prestored user preference. Alternatively, the NILM system may automatically determine a personalized energy management action at block 306 without the user request at block 304 based on the disambiguated energy use data and a prestored user preference.

At block 308, the NILM system may provide the personalized energy management action to the user by visually presenting the personalized energy management action, audibly presenting the personalized energy management action, or tactically presenting the personalized energy management action.

At block 310, the NILM system may receive instruction from the user in response to providing the personalized energy management action, and at block 312, perform a task consistent with the user instruction and providing a confirmation to the user upon completing the task. Alternatively, at block 314, the NILM system may automatically perform a task consistent with the personalized energy management action, and providing a confirmation to the user upon completing the task.

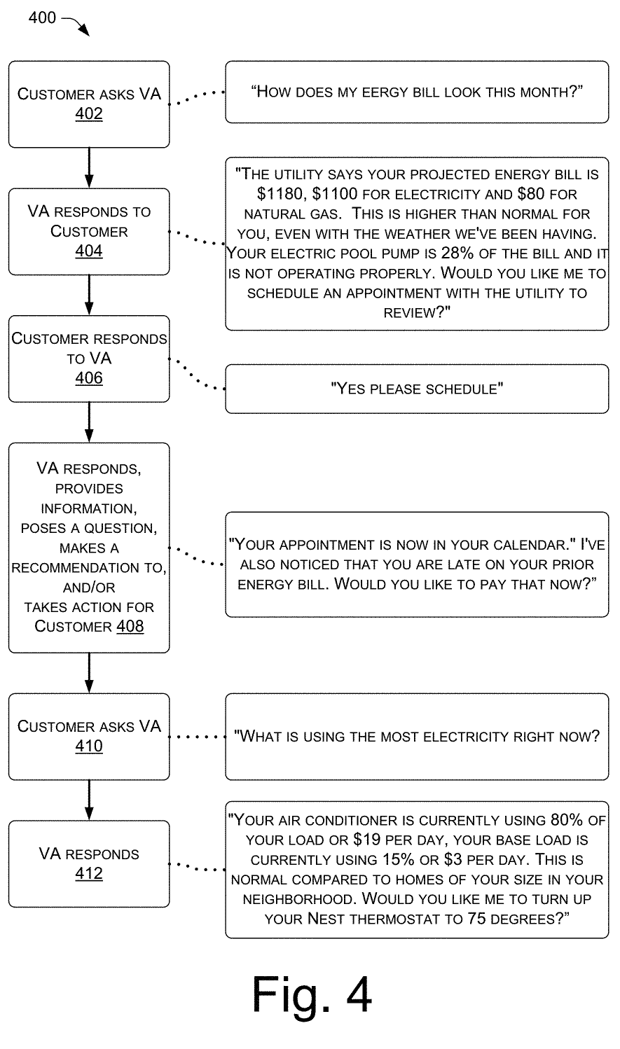

FIG. 4 is an example conversation flow 400 of a customer with a virtual assistant (VA) working in conjunction with the NILM system with reference to the process flow described above in FIG. 3. The VA may be any general or specific VA implemented in any of the devices and/or integrated home solutions as described above.

At block 402, the customer may ask the VA, “how does my energy bill look this month?” The customer may also specify the utility provider for electric or gas as the “energy bill” provider. The NILM system may also learn, or be programmed to understand, what the customer means by “my energy bill” and may not require the customer to specify the utility provider.

At block 404, the VA may respond to the customer's inquiry, and may additionally provide a suggestion, which may be personalized, “The Utility says your projected energy bill is $1180, $1100 for electricity and $80 for natural gas. This is higher than normal for you, even with the weather we've been having. Your electric pool pump is 28% of the bill and it is not operating properly. Would you like me to schedule an appointment with the Utility to review?”

At block 406, the customer may respond “Yes please schedule.” Based on the customer's response, the VA and the NILM system may automatically enter the appointment into the customer's electronic calendar.

At block 408, the VA may respond “Your appointment is now in your calendar.” The VA may also include an additional response related to the topic, such as “I've also noticed that you are late on your prior energy bill. Would you like to pay that now?” The customer may respond affirmatively and perform bill payment, for example, by using checking or credit card, or the customer may respond negatively and the conversation may proceed.

At block 410, the customer may ask “What is using the most electricity right now?”

At block 412, the VA may respond “Your air conditioner is currently using 80% of your load or $19 per day, your base load is currently using 15% or $3 per day. This is normal compared to homes of your size in your neighborhood. Would you like me to turn up your thermostat to 75 degrees?” Based on the customer's response, an action, specified by the customer or consistent with the VA's suggestion, may be taken. Additionally, or alternatively, decisions, such as turning up the thermostat to 75 degrees, may be automatically made and corresponding actions taken. For example, an energy efficiency decision can be prestored and a specific action from that decision may be automatically taken.

The conversation may continue depending on other topics identified by the VA or by the customer, with relevant information shared and action taken if desired.

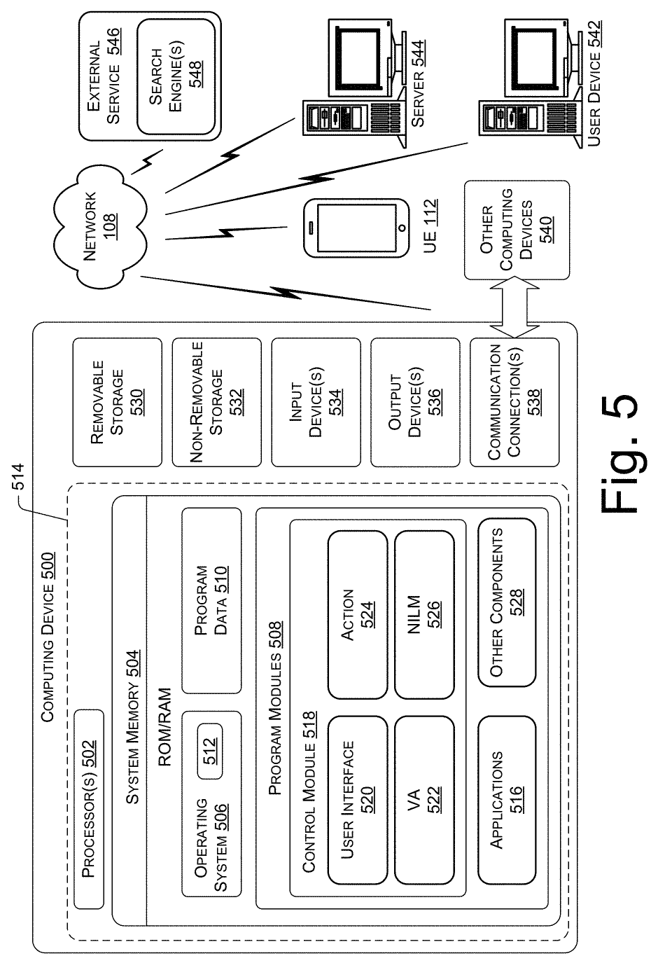

FIG. 5 is an example computing device 500 that may implement the system and methods for personalizing actionable energy management.

The techniques and mechanisms described herein may be implemented by multiple instances of the computing device 500, as well as by any other computing device, system, and/or environment. The computing device 500 shown in FIG. 5 is only one example of a computing device and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The computing device 500 may include one or more processors 502 and system memory 504 communicatively coupled to the processor(s) 502. The processor(s) 502 may execute one or more modules and/or processes to cause the computing device 500 to perform a variety of functions. In some embodiments, the processor(s) 502 may include a central processing unit (CPU), a graphics processing unit (GPU), both CPU and GPU, or other processing units or components known in the art. Additionally, each of the processor(s) 502 may possess its own local memory, which also may store program modules, program data, and/or one or more operating systems.

Depending on the exact configuration and type of the computing device 500, the system memory 504 may be volatile, such as RAM, non-volatile, such as ROM, flash memory, miniature hard drive, memory card, and the like, or some combination thereof. The system memory 504 may include an operating system 506, one or more program modules 508, and may include program data 510. The operating system 506 may include a component based framework 512 that may support components including properties and events, objects, inheritance, polymorphism, reflection, and may provide an object-oriented component-based application programming interface (API). The computing device 500 may be of a very basic illustrative configuration demarcated by a dashed line 514. A terminal may have fewer components but may interact with a computing device that may have such a basic configuration.

The program modules 508 may include, but are not limited to, applications 516, a control module 518, a user interface 520, a VA module 522, Action Module 524, NILM module 526, and/or other components 528.

The computing device 500 may have additional features and/or functionality. For example, the computing device 500 may also include additional data storage devices (removable and/or non-removable) such as, for example, magnetic disks, optical disks, or tape. Such additional storage is illustrated in FIG. 5 as removable storage 530 and non-removable storage 532.

The computing device 500 may also have input device(s) 534 such as a keyboard, a mouse, a pen, a voice input device, a touch input device, and the like. Output device(s) 536, such as a display, speakers, a printer, and the like, may also be included.

The computing device 500 may also contain communication connections 538 that allow the computing device 500 to communicate with other computing devices 540, over a network, such as the network 108. By way of example, and not limitation, communication media and communication connections may include wired media such as a wired network or direct-wired connections, and wireless media such as acoustic, radio frequency (RF), infrared, and other wireless media. The communication connections 538 are some examples of communication media. Communication media may typically be embodied by computer readable instructions, data structures, program modules, and the like.

FIG. 5 also illustrates a block diagram of an example operating environment where the example system may operate. For example, various embodiments of the system may operate on the computing device 500. The computing device 500 may interact with a user device 542 directly or indirectly. The computing device 500 may also be connected to the network 108, which may provide access to other computing devices 540 including a server 544, the UE 112, and/or other connections and/or resources. Connections may be wired or wireless. The computing device 500 may also connect via the network 108 to an external service 546, having a search engine 548, which may provide disambiguated energy use data, information associated with the user request, such as weather forecast, air quality index, predicted energy cost for next season, and the like.

The implementation and administration of a shared resource computing environment on a single computing device may enable multiple computer users to concurrently collaborate on the same computing task or share in the same computing experience without reliance on networking hardware such as, but not limited to, network interface cards, hubs, routers, servers, bridges, switches, and other components commonly associated with communications over the Internet, as well without reliance on the software applications and protocols for communication over the Internet.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory, such as random access memory (RAM), and/or non-volatile memory, such as read-only memory (ROM), flash memory, etc. The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1-5. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### Illustrative Non-Intrusive Load Monitoring (NILM) Techniques

Various NILM techniques may be available for use in the methods, systems, and devices illustrated above. For example, traditional weather normalized building profile comparison may be provided by comparing interval data to known usage patterns of other similar building profiles.

Current transformer (CT) sensors may be installed within an electrical distribution board (breaker panel) inside the house 104 or socket sensors may be installed on traditional utility meter outside the house 104 for providing measurements necessary to institute NILM.

Appliance, or plug/outlet, level sensors may be installed for providing individual resources (electric, gas, and/or water) as non-aggregated NILM information.

Centralized predictive analytics from AMI meter data (at 1 second intervals, 5 to 30 minute intervals, or any appropriate and/or selected intervals) may provide NILM information.

For edge or hybrid predictive analytics from AMI meter data (1 second to sub second intervals, for example), where the analytics take place at the meter, only relevant results may be transmitted back via meter gateway to the house 104, or via centralized location or cloud, such as the network 108, for routing back to house 104, and near real time customer experience, decisions, and next steps may be presented.

Information from any one or more of the above sources, or parts thereof, may be combined to provide NILM data, and may be used in various associated systems and services when communicating with, and providing information or taking action for, the customer.

### Illustrative Load-Disaggregation Implementation Embodiments

The following are example implementation embodiments and use cases, where the systems described above may be integrated into a building, and provide information and ability to make a decision and/or take action by a user (e.g., a customer).

### Illustrative Implementation Embodiments—Residential

1. A customer may wish to get alerts when major appliances are using higher or lower consumption than normal, not functioning, allowed to be repaired or replaced. The customer may want to a) set different notification parameters for different pieces of equipment, b) get information on likely causes of alerts such as leaking hot water tank, etc., c) get one notification from the utility provider if it is a known outage, and/or have the option of a specific or general VA to give these notifications, based on when the customer is d) home, e) away, f) commuting, g) at a time that doesn't conflict with a schedule or calendar, or combinations thereof, or h) set a level of priority that would override other preferences, such as interrupting any scheduled or calendared event. For example, the customer may want to know how the bill would change if the customer were to change an appliance for another appliance with different attributes. The customer may be interested in a breakeven point analysis if the switch were made based on the cost of installing a new appliance. The attributes of the appliance may include different power sources, for example, gas or electricity. In places where only one type of energy is provided, inquiries may be used to determine whether an additional power source may be installed to an appliance, to a room, to a unit, to a building, to a property, to a region, among other location designations and sizes. Flags or codes to be set may include: A—Replace Appliance, B—Fix Appliance, C—Appliance Not Functioning, and L—Notify of Exceptional Cost/Usage.

2. A customer may wish to be able to set that the customer is “away” and receive alerts if the equipment behaves differently from expected. For example, a customer may like to set different notification parameters for different pieces of equipment, set date ranges for parameters, among others, or combinations thereof. Flags or codes to be set may include: N—Usage—When Away.

3. A customer may wish to be able to see how much a bill would reflect changes in home equipment. For example, if the customer were to add a hot tub, how much increase in the load would be estimated and therefore increasing the bill. For example, if the customer were to upgrade equipment, how much decrease in the load would be estimated and therefore decreasing the bill. Additionally, or alternatively, the customer may wish to ask a specific or general VA the questions above, and receive the same answers displayed on a device, such as the UE 112. The customer may wish to take into account factors specific to the customer, for example, weather and attributes of residence (sq. footage, insulation levels, previous energy audit information, other appliances, etc.). The customer may also wish to take into account any information on equipment's typical usage. Flags or codes to be set may include: J—Dollar Impact for Change in Equipment, and E—Compare Appliance to Alternatives.

4. A customer may wish to know when there is occupancy and/or vacancy in the home/business. For example, the customer may wish to know if equipment which represents someone is home and is in motion, and may wish to know when these actions happen after a long pause signaling someone has returned home. Flags or codes to be set may include: M—Is Grandma OK? Are kids home?

5. A customer may wish to be able to measure by consumption and dollars if upgrading equipment has resulted in efficiencies and/or cost savings. For example, a customer may wish to see the trend over time that reflects the date of the change. Flags or codes to be set may include: F—Determine EE Effectiveness.

6. A customer may wish to get notified if usage indicated value in getting assistance from a service provider through an in-person audit. For example, the customer may wish to receive this notification, which allows the customer to see why this audit would be of value. The customer may wish to see what the possible savings would be. The customer may wish to see how they compare to peers, for example, a neighbor or comparable size house. Flags or codes to be set may include: G—Supply Energy Audit.

7. A customer may wish to be able to easily see if equipment usage patterns match with optimal performance. For example, the customer may wish to take into account weather, attributes of the building (sq. footage, etc.). The customer may wish to take into account any information on equipment's typical usage. The system may preemptively prompt a customer to make a decision. For example, based on the projected weather, a VA may inform the customer that though it is expected to be hot outside, if the customer were to set the thermostat to a certain level, it is predicted to save a certain amount on the bill when compared to setting the thermostat to a different level. This may be useful in both heating and cooling situations.

8. A customer may wish to easily see equipment's usage pattern over time. For example, the customer may wish to be able to note any key events, such as new equipment, or equipment servicing to ensure that equipment is running more efficiently. The customer may wish to be able to tell a specific or general VA these key events and have the events stored.

9. A customer may wish to be able to set a goal for usage/cost for each equipment, and be able to track the progress. For example, the customer may wish to be given suggested goals based on historical data for the equipment for the usage and cost. A customer may wish to have a specific or general VA be able to set goals and alert the customer when off track, on track and/or met goals.

### Illustrative Implementation Embodiments—Commercial

1. A customer may wish to receive alerts when the equipment is using higher or lower consumption than normal, allowing the customer to make necessary adjustments. For example, the customer may wish to be able to set different notification parameters for different pieces of equipment. A customer may wish to receive information on likely causes of alerts such as leaking hot water tank, etc. The customer may wish to receive one notification from the relevant service provider if it is a known outage. A customer may wish to have the option of having multiple people receive the alerts.

2. A customer may wish to be able to easily see if the equipment usage pattern matches with optimal performance. For example, the customer may wish to take into account weather and attributes of the business (sq. footage, building type, hours of operation, etc.) The customer may wish to take into account any information on equipment's typical usage.

3. A customer may wish to be able to set that the customer is “closed” and have alerts if the equipment behaves differently from expected. For example, the customer may wish to set different notification parameters for different pieces of equipment. the customer may wish to set date ranges for parameters.

4. A customer may wish to easily see equipment's usage pattern over time. For example, the customer may wish to be able to note any key events, such as new equipment, or equipment servicing to ensure that equipment is running more efficiently.

5. A customer may wish to be able to see how much the bill would change with changes in equipment. For example, if the customer adds an additional oven, how much increase in the load would be estimated and therefore increasing the bill. For example, if the customer upgraded equipment, how much decrease in the load would be estimated therefore lowering the bill.

6. A customer may wish to be able to set a goal for usage/cost for each equipment and be able to track the progress. For example, the customer may wish to be given suggested goals based on historical data for equipment for the usage and cost. A customer may wish to have a specific or general VA be able to set goals and alert the customer when off track, on track and/or met goals.

7. A customer may wish to have an estimated bill figure to be used for budgeting/accrual purposes. For example, the customer may wish this figure to be able to take into account historical usage values and daily values to adjust for any variances in the billing cycle. The customer may wish to be able to track the estimated value to the actual bill.

8. A customer may like to know how major pieces of equipment impact the cost of goods/services sold. For example, the customer may wish to be able to input metrics about business, such as amount sold in dollars, quantity of pizzas made, vacancies, etc. The customer may wish to be able to see down to the equipment level, how much energy and cost per production unit. The customer may wish to easily forecast changes in production units and an estimated figure on how it will impact energy consumption and cost. The customer may wish to change the work shift of the business based on the above information.

### Illustrative Implementation Embodiments—Multi-Family

A customer may wish to know estimated bill figures for budgeting and accrual purposes regarding Multi-Family situations. For example, the customer may wish this figure to be able to take into account the differences in usages between families in Multi-family establishments. The customer may wish this figure to monitor variances in usage among commercial residences. The customer may wish to be able to track the estimated value to the actual billed value when a rental facility is used at different times in the year.

While the foregoing discussion of examples are discussed with respect to Residential, Commercial, and Multi-family settings, it is understood that any of the examples in one setting may be applicable to any of the other settings as well as settings not explicitly discussed, including, for example, but not limited to, mixed use, hybrid use, intermittent use, seasonal use, short term use, or combinations thereof, among others.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for personalizing actionable energy management comprising:
receiving disambiguated energy use data associated with a user;
receiving a user request from the user for energy use information associated with the disambiguated energy use data;
based on the disambiguated energy use data and the user request, determining a personalized energy management action; and
providing the personalized energy management action to the user.

2. The method of claim 1, wherein receiving the disambiguated energy use data includes:
receiving aggregated energy use data associated with the user; and
disambiguating the aggregated energy use data to generate the disambiguated energy use data.

3. The method of claim 2, wherein disambiguating the aggregated energy use data to generate the disambiguated energy use data includes:
transmitting the aggregated energy use data to an external service to be disambiguated; and
receiving the disambiguated energy use data from the external service.

4. The method of claim 3, wherein the external service applies a non-intrusive load monitoring (NILM) technique to the aggregated energy use data to generate the disambiguated energy use data.

5. The method of claim 4, wherein the NILM technique comprises at least one of artificial intelligence techniques, machine learning techniques, state machine modeling techniques, or operational research techniques.

6. The method of claim 1, wherein receiving the disambiguated energy use data includes receiving, from each of a plurality of devices, corresponding individual energy use data.

7. The method of claim 1, wherein determining the personalized energy management action is further based on:
at least one of artificial intelligence, machine learning, natural language, or operational research understanding applied to the user request; and
prestored user preferences regarding personalizing the energy consumption management.

8. The method of claim 7, wherein providing the personalized energy management action to the user includes at least one of:
visually presenting the personalized energy management action;
audibly presenting the personalized energy management action; or
tactically presenting the personalized energy management action.

9. The method of claim 1, further comprising:
receiving a user instruction from the user in response to providing the personalized energy management action to the user;
performing a task consistent with the user instruction; and
providing a confirmation to the user upon completing the task.

10. The method of claim 1, further comprising:
automatically performing a task consistent with the personalized energy management action; and
providing a confirmation to the user upon completing the task.

11. A system personalizing actionable energy management comprising:
one or more processors; and
memory communicatively coupled to the one or more processors, the memory storing computer-readable instructions executable by the one or more processors, that when executed by the one or more processors, cause the one or more processors to perform operations comprising:
receiving disambiguated energy use data associated with a user;
receiving a user request from the user for energy use information associated with the disambiguated energy use data;
based on the disambiguated energy use data and the user request, determining a personalized energy management action; and
providing the personalized energy management action to the user.

12. The system of claim 11, wherein receiving the disambiguated energy use data includes:
receiving aggregated energy use data associated with the user; and
disambiguating the aggregated energy use data to generate the disambiguated energy use data.

13. The system of claim 12, wherein disambiguating the aggregated energy use data to generate the disambiguated energy use data includes:
transmitting the aggregated energy use data to an external service to be disambiguated; and
receiving the disambiguated energy use data from the external service.

14. The system of claim 13, wherein the external service applies a non-intrusive load monitoring (NILM) technique to the aggregated energy use data to generate the disambiguated energy use data.

15. The system of claim 14, wherein the NILM technique comprises at least one of artificial intelligence techniques, machine learning techniques, state machine modeling techniques, or operational research techniques.

16. The system of claim 11, wherein receiving the disambiguated energy use data includes receiving, from each of a plurality of devices, corresponding individual energy use data.

17. The system of claim 11, wherein determining the personalized energy management action is further based on:
at least one of artificial intelligence, machine learning, natural language, or operational research understanding applied to the user request; and
prestored user preferences regarding personalizing the energy consumption management.

18. The system of claim 17, wherein providing the personalized energy management action to the user includes at least one of:
visually presenting the personalized energy management action;
audibly presenting the personalized energy management action; or
tactically presenting the personalized energy management action.

19. The system of claim 11, wherein the operations further comprise:
receiving a user instruction from the user in response to providing the personalized energy management action to the user;
performing a task consistent with the user instruction; and
providing a confirmation to the user upon completing the task.

20. The system of claim 11, wherein the operations further comprise:
automatically performing a task consistent with the personalized energy management action; and
providing a confirmation to the user upon completing the task.

21. A non-transitory computer-readable storage medium storing computer-readable instructions executable by one or more processors, that when executed by the one or more processors, cause the one or more processors to perform operations comprising:
receiving disambiguated energy use data associated with a user;
receiving a user request from the user for energy use information associated with the disambiguated energy use data;
based on the disambiguated energy use data and the user request, determining a personalized energy management action; and
providing the personalized energy management action to the user.

22. The non-transitory computer-readable storage medium of claim 21, wherein receiving the disambiguated energy use data includes:
receiving aggregated energy use data associated with the user; and
disambiguating the aggregated energy use data to generate the disambiguated energy use data.

23. The non-transitory computer-readable storage medium of claim 22, wherein disambiguating the aggregated energy use data to generate the disambiguated energy use data includes:
transmitting the aggregated energy use data to an external service to be disambiguated; and
receiving the disambiguated energy use data from the external service.

24. The non-transitory computer-readable storage medium of claim 23, wherein the external service applies a non-intrusive load monitoring (NILM) technique to the aggregated energy use data to generate the disambiguated energy use data.

25. The non-transitory computer-readable storage medium of claim 24, wherein the NILM technique comprises at least one of artificial intelligence techniques, machine learning techniques, state machine modeling techniques, or operational research techniques.

26. The non-transitory computer-readable storage medium of claim 21, wherein receiving the disambiguated energy use data includes receiving, from each of a plurality of devices, corresponding individual energy use data.

27. The non-transitory computer-readable storage medium of claim 21, wherein determining the personalized energy management action is further based on:
at least one of artificial intelligence, machine learning, natural language, or operational research understanding applied to the user request; and
prestored user preferences regarding personalizing the energy consumption management.

28. The non-transitory computer-readable storage medium of claim 27, wherein providing the personalized energy management action to the user includes at least one of:
visually presenting the personalized energy management action;
audibly presenting the personalized energy management action; or
tactically presenting the personalized energy management action.

29. The non-transitory computer-readable storage medium of claim 21, wherein the operations further comprise:
receiving a user instruction from the user in response to providing the personalized energy management action to the user;
performing a task consistent with the user instruction; and
providing a confirmation to the user upon completing the task.

30. The non-transitory computer-readable storage medium of claim 21, wherein the operations further comprise:
automatically performing a task consistent with the personalized energy management action; and
providing a confirmation to the user upon completing the task.
